(19) United States
(12) Patent Application Publication
(10) Pub. No.: US 2006/0055630 A1
(43) Pub. Date: Mar. 16, 2006

(54) Chromatically enhanced display

(76) Inventors: Tak Meng Cheang, Persiaran (MY); Fook Chuin Ng, Mak Mandin (MY); Choon Guan Ko, Lorong Pekaka Satu (MY); Choon Keat Chew, Ipoh Garden South (MY)

Correspondence Address: AVAGO TECHNOLOGIES, INC., P.O. BOX 1920, DENVER, CO, 80201-1920, US

(21) Appl. No.: 10/941,321

(22) Filed: Sep. 15, 2004

(51) Int. Cl. G09G 3/06

(52) U.S. Cl. 345/44

(57) ABSTRACT

A display and method for displaying data are disclosed. The display includes a light source and a gauge that displays a quantity. The gauge is illuminated by the light source that has a color specified by a first control signal. A controller generates the first control signal based on the quantity such that the light source generates light of a first color if the quantity is within a first range and light of a second color if the quantity is in a second range. In one embodiment, the light source is characterized by an intensity specified by a second control signal, and the controller generates a second control signal based on the quantity such that the light intensity has a first intensity value when the quantity is in a third range and a second intensity value when the quantity is in a fourth range.

### BACKGROUND OF THE INVENTION

The present invention can be more easily understood with reference to a vehicle speedometer; however, it will become apparent from the following discussion that the present invention can be applied to a variety of displays. Most vehicles that are used on the public highways are equipped with a speedometer that displays the speed of the vehicle to the driver. The speedometer typically utilizes a pointer that rotates over a display having the various possible speeds thereon. Alternatively, the vehicle speed may be displayed as a digital readout. In either case, the vehicle design assumes that the driver periodically notes the driver's speed by looking directly at the speedometer and adjusts the speed to confirm to the limits associated with the roadway on which the vehicle is being operated. Unfortunately, the driver's attention is often focused on other tasks, and hence, the driver is not aware that the vehicle's speed is outside the limits allowed by the local laws until some other event calls the driver's attention to the vehicle's speed.

A similar problem exists for other gauges in the driver's console such as the fuel gauge. For example, the temperature of the cooling system is displayed in a gauge on the dashboard. The driver typically does not look at this gauge on a regular basis. Hence, if the engine overheats, the driver is not aware of the condition until some other event draws the driver's attention to the problem. By that time, damage may have already been done to the engine, or the engine may stop, leaving the vehicle without power, and hence, in danger of being hit.

In some auto designs, an additional light is included next to one or more of the gauges. This warning light becomes illuminated if the gauge is out of its normal operating range. For example, if the fuel level decreases to below a predetermined reserve level, a small light next to the fuel gauge becomes illuminated. The additional light draws the driver's attention to the low fuel condition. However, adding additional lights of this type to the gauges on the display increases the cost of the display. In addition, this type of warning light can only signal a binary condition. It does not signal any intermediate states. Finally, these warning lights are often too small to be noticed if the driver is not looking directly at the display.

### SUMMARY OF THE INVENTION

The present invention includes a display and method for displaying data. The display includes a light source and a gauge that displays a quantity. The gauge is illuminated by the light source that has a color specified by a first control signal. A controller generates the first control signal based on the quantity such that the light source generates light of a first color if the quantity is within a first range and light of a second color if the quantity is in a second range. In one embodiment, the light source is characterized by an intensity specified by a second control signal, and the controller generates the second control signal based on the quantity such that the light intensity has a first intensity value when the quantity is in a third range and a second intensity value when the quantity is in a fourth range. In one embodiment, the light intensity has a time varying pattern in the fourth range. In one embodiment, the controller includes a database for storing the first and second ranges. The first and second ranges can be chosen based on global positioning data in one embodiment. In one embodiment, the first and second ranges can be input by an operator. Displays having a plurality of said gauges can also be constructed. In one embodiment, a common light source is used to illuminate all of the gauges in a multi-gauge display. The color of the light is set such that the light source generates light of a first color if the quantities displayed by the gauges are all within the first range specified for each gauge and light of a second color if any of the quantities is in the second range specified for that gauge. In one embodiment, a third range is specified for each quantity and the controller varies the light intensity if any of the quantities are in the third range specified for that gauge. The light intensity can also be characterized by a time-varying pattern if any of the quantities are in a fourth range specified for that gauge.

### BRIEF DESCRIPTION OF THE DRAWINGS

FIG. 1 is a frontal view of display according one embodiment of the present invention.

FIG. 2 is a cross-sectional view through line 2-2 shown in FIG. 1.

FIG. 3 is a block diagram of a light source according to one embodiment of the present invention.

### DETAILED DESCRIPTION OF PREFERRED EMBODIMENTS OF THE INVENTION

The present invention is based on the observation that the color of light emanating from a gauge on the display console can be perceived by the driver without requiring the driver to look directly at the gauge. Hence, if a display's color changes from one color to another, the driver can be alerted to a change in the condition of the quantity represented by the gauge in question. Thus alerted, the driver can look directly at the console and gauge in question to determine the cause of the change in condition signaled by the change in color. Since the gauges include a light source to illuminate the gauges, no additional light sources are needed, provided the light source has a color that can be changed.

Light sources based on a plurality of LEDs are gaining favor for use in many applications because of the long lifetimes associated with such sources and the high efficiency of conversion of the electrical power to light. In such sources, the perceived color of the light is determined by the ratio of the drive currents to the various LEDs. The total light intensity is determined by the current through the LEDs. Hence, both the intensity of light and the color of the light can be easily altered. In many LED-based light sources, circuitry is already present for independently varying the current through the various LEDs to compensate for aging effects.

Consider a speedometer that includes a needle that rotates to point to the speed of the vehicle. The speedometer must be equipped with an illumination system that is typically used for nighttime viewing. In the present invention, the illumination system is utilized to signal the speed of the vehicle relative to predetermined set points. For example, the illumination system can include a light source that is capable of providing a plurality of colors. If the speed is below a predetermined set point, the light source is set to display a first color, e.g., blue. When the speed increases to a value above a second set point, the light source is set to display a second color, e.g., orange. If the speed increases above the third set point, the color changes again to red. This change in color will be visible in the peripheral field of view of the driver even when the driver is looking out of the windshield, and hence, the driver will become aware of the change in the condition of the speed of the vehicle.

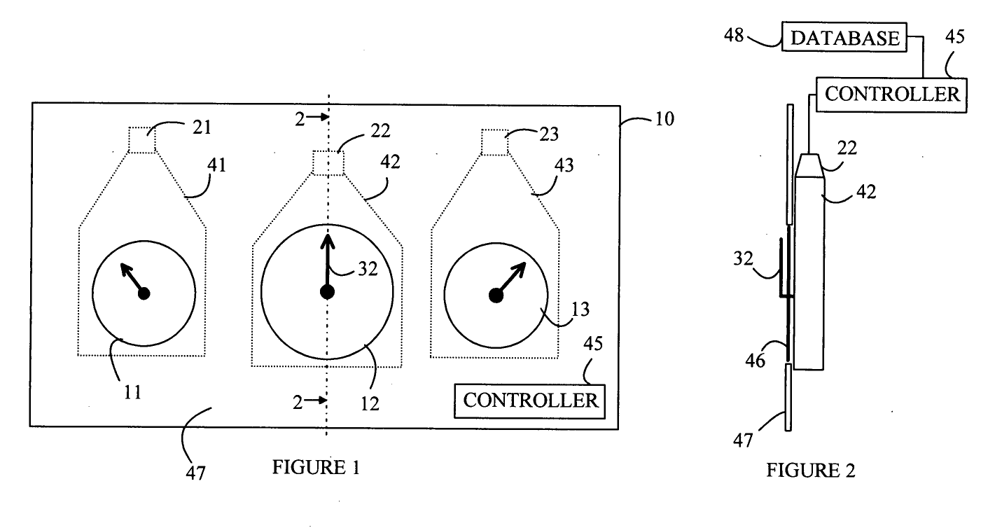

Refer now to FIGS. 1 and 2, which illustrate a display 10 according to one embodiment of the present invention. FIG. 1 is a frontal view of display 10, and FIG. 2 is a cross-sectional view through line 2-2. Display 10 includes three gauges shown at 11-13. Each gauge includes a translucent region 46 set in an opaque panel 47. The transparent region is illuminated from the back by an illumination system that includes a light source and a light pipe. The light sources corresponding to gauges 11-13 are shown at 21-23, respectively. The light pipes corresponding to gauges 11-13 are shown at 41-43, respectively. The light pipes are constructed such that the area of the transparent window corresponding to each gauge is illuminated in an approximately constant manner.

Refer now to FIG. 2. Gauge 12 includes a pointer 32 that indicates a quantity associated with that gauge. The quantity associated with each gauge can take on values that vary between a minimum and a maximum value within a predetermined range. The actual position of the pointer is controlled by a controller 45 that converts a signal corresponding to that quantity to a voltage or current that operates the gauge. Controller 45 also controls the color of the light emitted by light source 22 associated with gauge 12. For example, the color can be varied continuously from blue to red as the quantity varies from its minimum to maximum value. In another embodiment, the range is divided into regions. In this case, each region has a corresponding color. For example, if the gauge indicates the vehicle speed, the speeds in excess of a predetermined speed can be illuminated in red, while those speeds less than that speed are illuminated in green or blue. The ranges used to define the color mapping are stored in a database 48 in this embodiment.

Light source 22 is preferably an LED based light source that includes LEDs of different colors. For the purposes of this discussion, it will be assumed that light source 22 includes red, green, and blue LEDs. The intensity of light from each LED is controlled by controlling the drive current to that LED. The color of the light generated is determined by the relative intensities of the LEDs.

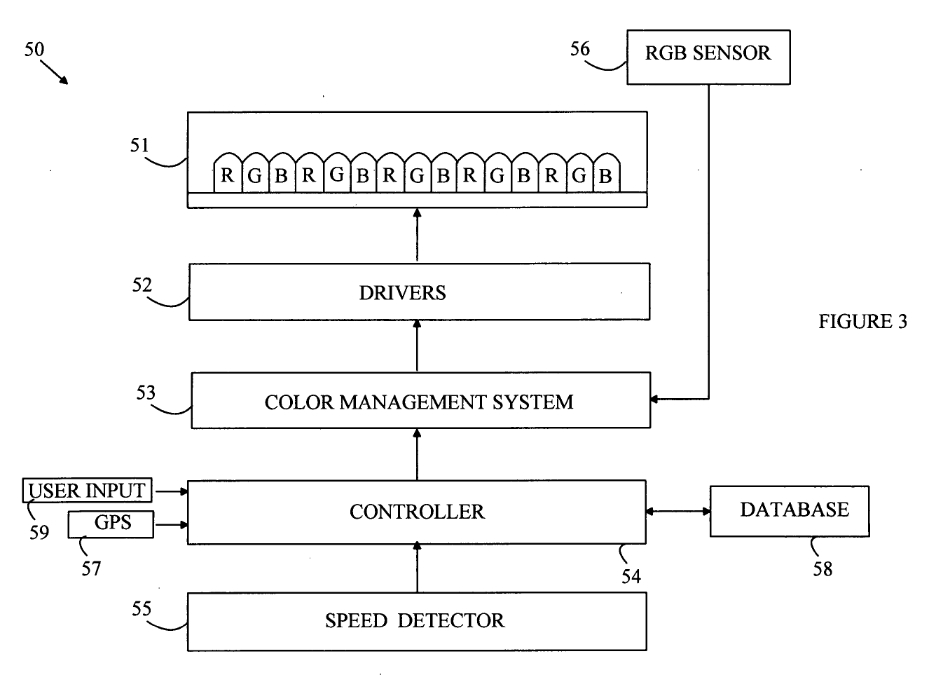

Refer now to FIG. 3, which is a block diagram of a light source according to one embodiment of the present invention for use with a speedometer that utilizes a speed detector 55 to measure the speed of a vehicle. Light source 50 includes an LED array 51 that includes LEDs having a plurality of colors. In the embodiment shown in FIG. 3, the LEDs generate red, blue, and green light. In addition, light source 50 may include a plurality of LEDs of each color if the desired maximum light intensity is greater than that available from a single set of LEDs. The drive current through the LEDs is set by an array of driver circuits shown at 52. The drive current through the LEDs is set by a color management controller 53 that sets the drive currents in response to a signal from controller 54 that specifies the desired color and intensity. It should be noted that aging effects in LEDs are significant. The output intensity and color can shift significantly over the lifetime of the LED. Hence, color management controller 53 preferably measures the actual color being generated by LED array 51 using color sensor 56 and adjusts the drive currents to correct for any aging effects.

In general, the mapping between color and gauge reading will depend on the quantity being displayed by the gauge. In the example shown in FIG. 3, it is assumed that the gauge being controlled is the speedometer. The color mapping in this case is ideally set by the relationship between the current speed and some measure of the maximum allowed speed on the particular road on which the vehicle is operating. In the simplest case, the color mapping is set relative to some maximum speed that is independent of the road. For example, the color mapping can assign a green color to speeds below 55 MPH, a yellow color to speeds between 55 MPH and 70 MPH, and a red color for speeds over 70 MPH.

The specific set points for the color mapping can also be input by the user via an input device 59. A variety of input devices are already in use in automobiles for specifying information needed to operate the vehicles many environmental and sound system controls. The set points can also be stored as a group of settings that are selected as a whole by the user by inputting data specifying the group using the input device. For example, the database can have a first color mapping for freeways, a second mapping for city streets, and so on.

Navigation systems based on the global positioning system are now relatively common. If the vehicle is equipped with a navigation system that includes a position detector 57, the set points can be set with the aid of a database 58 that looks up the speed limit for the current road. Such an embodiment would require a minor upgrade to the databases currently supplied with such systems. The speed database can be supplied as a separate database or as a new database from the manufacturer of the navigation system.

For many of the gauges, the set points for the color mapping can be set permanently at the factory. For example, if the gauge displays engine temperature, the mapping will be set at the factory with color change points set to alert the driver to high temperature situations. The color can be set to change abruptly if the temperature exceeds a predetermined set point or the color can be set to change continuously from blue to green to red as the temperature proceeds from lower to higher temperatures.

The intensity of the display can also be changed in addition to the color of the display. For example, the display can be caused to flash on and off if the quantity being displayed exceeds a predetermined set point.

The above-described embodiments utilize a separate light source and color controller for each gauge. However, embodiments in which pluralities of gauges share a single light source can also be constructed. In such systems, each gauge has a mapping that includes a plurality of ranges for the quantity being displayed. In one range, the quantity is normal. In a second range, the quantity may be in a warning range. In a third range, the quantity may be out of the normal range to be in a dangerous range, and so on. In the simplest case, the color mapping has one color corresponding to each range independent of the quantity in question. For example, if a quantity is in its normal range, green is assigned. If the quantity is in a warning range, yellow is assigned. If the quantity is in a danger range, red is assigned, and so on. The color assigned to the display is that color assigned to the quantity that is furthest from its normal range. Hence, the display will be green if all the gauges are in their respective normal ranges. If any gauge is in its warning range, the display color will move to yellow. If one of the gauges is in its danger range, the display color will move to red.

The above-described embodiments of the present invention utilize analog displays. However, the present invention can also be applied to digital displays. For example, any of the analog gauges shown in FIG. 1 could be replaced by a backlit digital display. Backlit digital displays such as those based on liquid crystal displays (LCDs) are well adapted to the present invention. Such displays include a light source that is modulated by the LCD display pixels. In one class of displays, the individual pixels block or transmit light from a light source located behind the display. In such systems, the light source need only be replaced by a variable color display as described above.

The above-described embodiments of the present invention alter the display based on the quantities that are normally displayed on the instrument panel of a car. However, the display color and/or intensity can also be altered in response to a condition that is not normally displayed on the instrument panel. For example, if the automobile is equipped with a sensor that provides information on the distance to the vehicle in front of the automobile, the display parameters can be altered if that distance is less than some predetermined distance. The range of distance values used to set the color mapping can also depend on the speed of the vehicle.

The present invention can also be used with other forms of detectors that can be monitored by the controller. For example, a detector that senses a predetermined emergency vehicle light pattern to warn the driver of an emergency vehicle approaching his or her vehicle can be incorporated in the vehicle and used to control the display color or intensity pattern. Similarly, a detector that detects the radio frequency signal used by emergency vehicles to change traffic signals can also be incorporated and used to alter the display color or intensity pattern.

Various modifications to the present invention will become apparent to those skilled in the art from the foregoing description and accompanying drawings. Accordingly, the present invention is to be limited solely by the scope of the following claims.

What is claimed is:

1. A display comprising:
a light source that generates light of a color specified by a first control signal;
a gauge that displays a quantity, said gauge being illuminated by said light source;
a controller that generates said first control signal based on said quantity such that said light source generates light of a first color if said quantity is within a first range and light of a second color if said quantity is in a second range.

2. The display of claim 1 wherein said light source comprises a plurality of LEDs.

3. The display of claim 1 wherein said light generated by said light source is characterized by an intensity specified by a second control signal and wherein said controller generates said second control signal based on said quantity such that said light intensity has a first value when said quantity is in a third range and a second value when said quantity is in a fourth range.

4. The display of claim 1 wherein said light intensity has a time varying pattern in said fourth range.

5. The display of claim 1 wherein said controller comprises a database for storing said first and second range.

6. The display of claim 5 further comprising an input port for receiving global positioning data, said database storing said first and second ranges as a function of said global positioning data.

7. The display of claim 1 wherein said controller comprises an input device for receiving said first and second range from an operator.

8. A display comprising a plurality of component displays, each component display comprising:
a light source that generates light of a color specified by a first control signal;
a gauge that displays a quantity, said gauge being illuminated by said light source;
a controller that generates said first control signal based on said quantity such that said light source generates light of a first color if said quantity is within a first range and light of a second color if said quantity is in a second range.

9. The display of claim 8 wherein said light generated by said light source is characterized by an intensity specified by a second control signal and wherein said controller generates said second control signal based on said quantity such that said light intensity has a first value when said quantity is in a third range and a second value when said quantity is in a fourth range.

10. The display of claim 8 wherein said light intensity in one of said component displays has a time varying pattern in said fourth range.

11. The display of claim 8 wherein said controller in one of said component displays comprises a database for storing said first and second range.

12. The display of claim 11 wherein said controller in one of said component displays comprises an input port for receiving global positioning data, said database storing said first and second ranges as a function of said global positioning data.

13. The display of claim 8 wherein said controller in one of said component displays comprises an input device for receiving said first and second range from an operator.

14. A display comprising:
a light source that generates light of a color specified by a first control signal; and
a plurality of component displays, each component display comprising a gauge that displays a quantity, said gauge being illuminated by said light source, said display further comprising;
a controller that stores a first range and a second range for said quantity displayed by each gauge, said first and second ranges being particular to that gauge and that generates said first control signal based on said quantities displayed by said gauges such that said light source generates light of a first color if said quantities are within said first range specified for each gauge and light of a second color if any of said quantities is in said second range specified for that gauge.

15. The display of claim 14 wherein said controller also monitors a detector having an output that is not displayed on said display and wherein said controller alters said color of said light if said detector output is in a predetermined range.

16. The display of claim 14 wherein said light generated by said light source is characterized by an intensity specified by a second control signal and wherein said controller stores a second range and a third range for said quantity displayed by each gauge, said third and fourth ranges being particular to that gauge and said controller generates said second control signal based on said quantities displayed by said gauges such that said light source generates light of a first intensity if said quantities are within said third range specified for each gauge and light of a second intensity if any of said quantities is in said third range specified for that gauge.

17. The display of claim 14 wherein said light intensity has a time varying pattern if one of said quantities is in said fourth range for that quantity.

18. The display of claim 14 wherein said controller comprises a database for storing said first and second ranges for each of said gauges.

19. The display of claim 18 wherein said controller comprises an input port for receiving global positioning data, said database storing said first and second ranges for one of said gauges as a function of said global positioning data.

20. The display of claim 14 wherein said controller comprises an input device for receiving one of said first and second ranges from an operator.

21. A method for displaying data representing a quantity comprising:
displaying said quantity in a gauge that is illuminated by light of a first color and intensity if said quantity is within a first range; and
causing said gauge to be illuminated by a light of a second color if said quantity is within in a second range.

22. The method of claim 21 further comprising altering said intensity of said light if said quantity is in a third range.

23. The display of claim 21 wherein said light intensity has a time varying pattern if said quantity is in a fourth range.
